(19) United States
(12) Patent Application Publication
(10) Pub. No.: US 2019/0048712 A1
(43) Pub. Date: Feb. 14, 2019

(54) METHOD FOR MONITORING QUALITY ASSURANCE OF CHEMICALS IN SUBSEA UMBILICAL SYSTEMS TO AVOID BLOCKAGE

(71) Applicant: Baker Hughes, a GE company, LLC, Houston, TX (US)

(72) Inventors: David Wayne Jennings, Houston, TX (US); Paul Robert Stead, Sugar Land, TX (US); Michael J. Deighton, Fulshear, TX (US); Sunder Ramachandran, Sugar Land, TX (US); Tudor C. Ionescu, Houston, TX (US)

(73) Assignee: Baker Hughes, a GE company, LLC, Houston, TX (US)

(21) Appl. No.: 16/053,087

(22) Filed: Aug. 2, 2018

Related U.S. Application Data
(60) Provisional application No. 62/543,629, filed on Aug. 10, 2017.

(51) Int. Cl. E21B 47/10; E21B 37/06; E21B 47/06; E21B 41/02; G01N 9/00; G01N 15/06

(52) U.S. Cl. CPC E21B 47/101; E21B 37/06; E21B 47/065; G01N 15/0606; G01N 9/002; G01N 15/06; E21B 41/02

(57) ABSTRACT

A method for monitoring the quality, stability, and potential deposition of process treatment fluids pumped into subsea umbilical systems includes monitoring a resonator sensor in the subsea umbilical system having a fluid flowing therethrough, where the resonator sensor can be a torsional resonator or a symmetrical sensor, and the method also includes detecting a change in resonance of the resonator sensor indicating the deposition of a chemical species on the resonator sensor or significant change in process treatment fluid physical viscosity and density properties. The resonator sensor can also measure the amount of chemical species deposited. The fluid may be an organic and/or aqueous based fluid. The method includes performing at least one action in response to detecting the change, which action prevents or inhibits blockage of the subsea umbilical system.

### CROSS-REFERENCE TO RELATED APPLICATION

This application claims the benefit of U.S. Provisional Application No. 62/543,629 filed Aug. 10, 2017, incorporated herein by reference in its entirety.

### TECHNICAL FIELD

The present invention relates to methods for monitoring the quality and stability of process treatment fluids pumped into subsea umbilical systems, and more particularly relates in one non-limiting embodiment to methods for detecting the presence of and/or measurement of the relative rates of amounts of unstable chemical species from the process treatment fluids that could potentially deposit in the subsea umbilical systems having process treating fluids flowing therethrough.

### BACKGROUND

Production of hydrocarbon fluids comes with various threats to the processes and systems used. The main threats are related to maintaining flow assurance and integrity of equipment. Flow assurance management is generally related to controlling foulants that deposit on or plug equipment. Integrity management is generally related to controlling corrosion in well tubing and flowlines. To aid hydrocarbon production, various process treatment fluids are often applied to prevent or reduce problems. These process treatment fluids include foulant inhibitors, corrosion inhibitors, demulsifiers, and hydrogen sulfide scavengers among others.

For flow assurance problems, various types of foulants, contaminants and chemical species pose problems during production of hydrocarbon fluids. Foulants are materials within production fluids or refinery streams that may become destabilized and deposit on equipment, which can cause problems with the fluid during extraction, transporting, processing, refining, combustion, and the like. Examples of foulants of concern include, but are not necessarily limited to, asphaltenes, waxes, scale, gas hydrates, naphthenates, naphthenic acid salts, iron sulfide, coke, and the like.

For the purposes herein, production fluids or formation fluids are the products from a reservoir at the time the fluids are produced. Production fluids consist of petroleum hydrocarbon liquids, gases, and produced water. The petroleum hydrocarbon liquids contain a large number of components with very complex compositions. Some of the potentially fouling-causing components present in the petroleum fluids, for example wax and asphaltenes, are generally stable in the crude oil under equilibrium reservoir conditions, but may precipitate or deposit as temperatures, pressures, and overall fluid compositions change as the crude oil is removed from the reservoir during production. Waxes comprise predominantly high molecular weight paraffinic hydrocarbons, i.e. alkanes. Asphaltenes are typically dark brown to black-colored amorphous solids with complex structures and relatively high molecular weights. The produced water consists of brine solutions containing ions from various salts, such as, but not limited to, Na⁺, K⁺, Ca⁺², Ba⁺², Sr⁺², Mg⁺², Si⁺², Fe⁺², Cl⁻, HCO⁻³, and SO₄⁻². The potentially fouling-causing scale from the produced water, for example CaCO₃, BaSO₄, and CaSO₄, are generally stable in the produced water under equilibrium reservoir conditions, but may precipitate and deposit as temperatures, pressures, and overall fluid compositions change as the produced water is removed from the reservoir during production.

Asphaltenes are most commonly defined as that portion of petroleum, which is insoluble in heptane. Asphaltenes exist in crude oil as both soluble species and in the form of colloidal dispersions stabilized by other components in the crude oil. Asphaltenes may include a distribution of thousands of chemical species having chemical similarities, although they are by no means nearly all identical. In general, asphaltenes have higher molecular weights and are the more polar fractions of crude oil, and can precipitate upon pressure, temperature, and compositional changes in crude oil resulting from production, blending, or other mechanical or physicochemical processing. CO₂ flooding, gas injection, and commingling heavy crude oils with light crude oils or condensates during production are common blending operations which can cause asphaltene destabilization. Asphaltene precipitation and deposition can cause problems in subterranean reservoirs, upstream production facilities, mid-stream transportation facilities, refineries, and fuel blending operations. In petroleum production facilities, asphaltene precipitation and deposition can occur in near-wellbore reservoir regions, wells, flowlines, separators, and other equipment. Once deposited, asphaltenes present numerous problems for crude oil producers. For example, asphaltene deposits can plug downhole tubulars, wellbores, choke off pipes and interfere with the functioning of safety shut-off valves, and separator equipment. Asphaltenes have caused problems in refinery processes such as desalters, distillation preheat units, and cokers.

The waxes or paraffins in petroleum are primarily from alkanes—both normal and branched species. Normal alkanes comprise the majority of waxes in most crude oils. The longer the chain length of the wax, the more limited the solubility of the wax in crude oil, petroleum, and solvents. N-alkane chain lengths up to 100 carbons have been detected in crude oil. The wax appearance temperature is the temperature at which the first amount of wax starts to precipitate from a crude oil. Wax will deposit from a crude oil in well tubing, flowlines, subsea umbilical lines or processing equipment if the inner surface temperature of the well tubing, flowlines, subsea umbilical line or processing equipment is below the crude oil wax appearance temperature and a temperature gradient exists between the bulk crude oil temperature and the colder surface temperature. Wax deposition is common in many petroleum production facilities especially in operations in cold environments such as in deepwater subsea flow lines thereby requiring methods to manage the deposition. Wax deposition management strategies include both preventative and remediation methods. Preventative methods include use applications such as using active heating and insulation to keep flow streams warm; that is, above wax appearance temperatures. Remediation methods include operations such as pigging in flow lines and wireline cutting in well tubulars. Use of other management means such as application of chemical paraffin inhibitors are also used to reduce the amount of wax depositing.

When the formation fluid from a subsurface formation comes into contact with a pipe, a valve, or other production equipment of a wellbore, or when there is a decrease in temperature, pressure, or change of other conditions, foulants may precipitate or separate out of a well stream or the formation fluid, while the formation fluid is flowing into and through the wellbore to the wellhead. While any foulant separation or precipitation is undesirable in and by itself, it is much worse to allow the foulant precipitants to deposit or accumulate on equipment in the wellbore. Any foulant precipitant depositing on wellbore surfaces may narrow pipes and clog wellbore perforations, flow valves, and other well site and downhole locations. This may result in well site equipment failures and/or closure of a well. It may also slow down, reduce or even totally prevent the flow of formation fluid into the wellbore and/or out of the wellhead. Such deposits can be particularly troublesome and dangerous if the wellhead is on the ocean floor.

As mentioned, one technique to reduce the adverse effects of foulants within the formation fluids is to add foulant inhibitors to the fluids having potential fouling causing components. A “foulant inhibitor” is defined herein to mean an inhibitor that targets a specific foulant. Several foulant inhibitors may be added to reduce the adverse effects of each type of foulant, e.g. asphaltene foulant inhibitors, paraffin foulant inhibitors, hydrate foulant inhibitors, and scale foulant inhibitors all may be added to the fluid to decrease the adverse effects of each type of foulant, such as deposition, accumulation, and/or agglomeration of the foulant(s). Preventing or reducing the effects of foulants is extremely important for assuring production of petroleum hydrocarbon fluids. For production from deepwater subsea wells it is even more important than other production systems due to the high cost of equipment and difficulty and cost for making repairs or remediating foulant deposition. Depending on the size of the operation, deepwater production systems can cost up to four billion dollars and more. As such, if the deepwater production system is depending on foulant inhibitors, it is imperative that the foulant inhibitors are applied through the subsea umbilical systems without problems. Hence, insuring the quality and stability of process treatment fluids applied therein is of upmost importance.

Similarly, preventing corrosion in well tubing and flowlines is also of upmost importance. Tubing and flowlines with compromised integrity cannot be used and would require replacement. In deepwater subsea systems, this would entail hundreds of millions of dollars and months to years of downtime and deferred production causing further economic threat to economic viability of the deepwater production system. Even worse, compromised tubing and flowline integrity poses a threat to failure with consequences of potential leakage of hydrocarbon fluids causing significant damage to the environment and potential danger to the safety of operation personnel. Further, fines and penalties given to operators as a consequence of these leaks or spills add further to the cost of operations.

One common means to prevent or reduce corrosion is application of corrosion inhibitors as process treatment fluids. Corrosion inhibitors are widely depended on in the petroleum industry both in the industry as a whole and in its deepwater segment. The deepwater segment is the most dependent, however, due to the high cost and difficulty associated with the installation and replacement of well completions and flowlines. As such, just as with foulant inhibitor products, it is imperative that corrosion inhibitors are applied through the subsea umbilical systems without problems. Hence, insuring the quality and stability of process treatment fluids applied therein is of upmost importance.

Thus, it would be desirable to have better methods to monitor and detect any stability problems occurring in process treatment fluids being applied into subsea umbilical systems before irreversible problems occur that could plug and prevent use of lines in the umbilical system.

### SUMMARY

There is provided, in one form, a method for monitoring the quality and stability of process treatment fluids pumped into subsea umbilical systems that includes monitoring a resonator sensor in a subsea umbilical system having an organic and/or aqueous fluid flowing therethrough, where the resonator sensor is selected from the group consisting of a torsional resonator or a symmetrical sensor, and detecting a change in resonance of the resonator sensor indicating the deposition of a chemical species on the resonator sensor or significant change in process treatment fluid physical viscosity and density properties, and performing at least one action in response to detecting the change, which action prevents, inhibits and/or removes blockage in the subsea umbilical system.

### BRIEF DESCRIPTION OF THE DRAWINGS

FIG. 1 is a graph of temperature, viscosity and density over time for a wax-like polymer solution fluid under static conditions;

FIG. 2 is a graph of temperature, viscosity and density over time for the wax-like polymer solution fluid of FIG. 1 under flowing conditions;

FIG. 3 is a graph of temperature, viscosity and density over time for a wax-like polymer solution fluid different from that of FIGS. 1 and 2 under flowing conditions;

FIG. 4 is a graph of temperature, viscosity and density over time for a sample asphaltene inhibitor chemical fluid under flowing conditions;

FIG. 5 is a graph of temperature, viscosity and density over time for a sample demulsifier chemical fluid under flowing conditions; and

FIG. 6 is a graph of temperature, viscosity and density over time for a sample H₂S scavenger chemical fluid under flowing conditions.

### DETAILED DESCRIPTION

A method has been discovered for measuring the deposition of chemical species in a subsea umbilical system. The term “umbilical system” is used herein to refer to the complete umbilical system which includes, but is not necessarily limited to, the pumps, line, umbilical termination sled (UTS) (end point which distributes the individual tubes buddle within the line), and flying leads (distribution lines from UTS), or any of these or other components thereof. High pressure viscosity and/or density sensors within umbilical systems in subsea lines are used to continually monitor the viscosity and density properties of the chemicals within the umbilical's tubing cores. Monitoring the fluid properties can alert operators of potential problems such as product instability, introduction of erroneous products, and/or contamination of products which may cause umbilical plugging before excessive amounts of fluids are pumped through the umbilical. The methods described herein also provide a measure of quality assurance to verify that a suitable product with in-spec physical properties is being pumped through the umbilical.

It will be appreciated that in the context herein, “well” is defined to include a well in a subterranean formation for the production of hydrocarbons including but are not necessarily limited to, oil and gas, particularly petroleum, including subsea wells, although the methods herein could be applicable to water wells. “Flow lines” in the context herein are defined to include upstream, midstream and downstream flow lines, conduits, and pipes in hydrocarbon recovery and processing including, but are not necessarily limited to, blending in pipeline operations, terminals, marine fuels, refinery storage tanks, etc., as well as in the qualification of finished fuels including, but not necessarily limited to, diesel fuel. “Flow lines” are also defined to include any subsea umbilical line or system used to inject or deliver relatively small amounts of chemicals to a subsea wellhead, but also to other equipment. “Flow lines” also includes those lines used in the manufacture of polymers and other materials, and in any laboratory testing and processing appa-ratus where deposition of a chemical species is of a concern. In addition, in the manufacture of polymers, the methods described herein can be used to measure viscosity as a quality control parameter of the product polymer. In another process application, the ability to adjust or use the proper amount of caustic or other component could be handled or monitored by online density measurements.

In another non-limiting embodiment, the method may be practiced in the presence of other chemicals or materials found in subterranean reservoirs, upstream production facilities, mid-stream transportation facilities, refining operations, and fuel blending operations. These chemicals and/or materials include, but are not limited to, water, brine, surfactants, acids, inorganic scale, formation sand, formation clays, corrosion by-products, upstream petroleum production chemicals, and refinery processing chemicals. These chemicals may or may not affect the foulant stability, foulant deposition, and/or foulant inhibitor efficacy.

The fluid being measured may be an organic fluid, an aqueous fluid or a mixture thereof. In the case of subsea umbilical systems, the fluid may be a chemical being delivered to subsea equipment, such as a wellhead.

Suitable resonator sensors include but are not necessarily limited to a torsional resonator or a symmetrical sensor. In one non-limiting embodiment herein, the term “resonator sensor” does not encompass quartz crystal microbalances (QCMs), also known as quartz crystal resonators; that is, there is an absence of a QCM in the methods described herein.

The changes encountered by the chemical species in the fluid may be related to the separation or stability of foulant species, foulant species treated with inhibitors, or both. Typically, as chemical species precipitate and/or separate at or near the surface, they tend to form deposits, and when the deposits occur on a resonator sensor and its resonance is changed, the presence of the deposition of chemical species is detected. The change in resonance of the resonator sensor is a change including, but not necessarily limited to, a viscosity change, density change, and/or deposition build-up on the sensor. In the embodiment where the amount of change in resonance is detected over a time period related to deposition build-up it may be correlated to the amount of deposition of the chemical species on the resonator sensor, thus not only the presence but the amount of the chemical species depositing may potentially be measured.

In one non-limiting embodiment the method described herein may involve monitoring the resonance of the sensor for just detecting whether deposition of any unstable components is occurring and determining the location of deposition in subsea umbilical system through the use of multiple sensors placed in different locations in the umbilical system, for instance. Such information would be valuable to allow preventative action to be undertaken which potentially could prevent complete plugging of an umbilical line or system.

In a second non-limiting embodiment the method described herein may involve monitoring the resonator sensor to determine if significant changes in the physical properties of density and/or viscosity occur indicating potential introduction of an erroneous treatment fluid or contamination in the treatment fluid—occurring either before introduction into or while in the umbilical system. Such information is valuable as erroneous or contaminated fluids not only pose plugging concerns, but would likely not perform or have reduced performance in their intended function.

“Measuring” is defined herein to encompass the simple detection of the presence of a material, e.g. chemical species (in a non-limiting instance, asphaltenes) regardless of amount, but also encompasses detection and/or measurement of the amount of a chemical species or other material. In another non-limiting embodiment, detecting the change in resonance of the resonator sensor involves measuring a baseline reading of the resonator sensor where the resonator sensor is free of chemical species deposition thereon, then measuring a subsequent reading of the resonator sensor, and comparing the baseline reading with the subsequent reading to detect deposition of a chemical species on the resonator sensor, where there is a change in sensor response not due to viscosity and/or density changes thereby indicating chemical species deposition.

“Monitoring” is defined herein to mean measurements on a basis that includes continuous, periodic, aperiodic, and/or intermittent measurements, which measurements can be at regular or irregular intervals.

One non-limiting goal would be to install the resonator sensor directly in the subsea umbilical system—in either the umbilical tube lines or other sections such as an umbilical termination sled. A challenge is that umbilical tubes are relatively small and contained in a sheathed bundle with other tubes, electrical wires, sheathing, etc. and would not be relatively easy to install. Placement in the umbilical termination sled or similar location would provide much easier installation, however, this approach would limit installation to one single location rather than installing multiple sensors in the umbilical tubes which may run miles across the seafloor.

In more detail, resonator sensors that measure changes in viscosity and/or density of a fluid may be used. It can also be important to measure the temperature of the fluid to obtain an accurate understanding of the changes in viscosity and/or density. The temperature can be measured at any time during the method. In one non-limiting embodiment the resonator sensor should be highly accurate and provide reproducible inline measurements of both density and viscosity at process pressures up to 30,000 psi (2000 bar) and temperatures in excess of 400° F. (200° C.). A response time of about 1 second per reading permits monitoring of rapidly changing process parameters under conditions as extreme as subsea and ultra-deep oil, gas, and geothermal exploration and production, including measurement while drilling. One specific, non-limiting example is the DVM HPHT (high pressure, high temperature) density meter and viscometer available from Rheonics, Inc.

In another non-limiting embodiment the resonator sensors are suitable for non-intrusive direct inline measurements in a pressure range from 2-12,500 mPa·s over a temperature range from −20 to 200° C. (−4 to 400° F.). These conditions may be considered HPHT in one non-limiting embodiment. The resonator sensors are unaffected by external vibrations and are able to measure a wide range of viscosities and densities, as well as detect deposition build-up on the sensor. The resonator sensors are also able to perform measurements in solid-laden fluids. Some resonator sensors have a density sensor and a viscosity sensor adjacent to each other, where each sensor may be operated independently and where the results show no influence from the adjacent complementary sensor. That is, when one sensor is operated, its characteristics were independent of the presence or absence of its adjacent sensor. Further, these resonator sensors have extremely low orientation sensitivity and thus are not limited to horizontal or vertical positions.

The resonator sensors have a resonant frequency and/or damping that is responsive to fluid density and/or fluid viscosity, which alter their resonant frequency. Thus, detecting a change in the resonance of the resonator includes measuring a parameter including a resonant frequency, a resonant frequency shift, and/or damping. These parameters are then correlated to fluid physical properties, including viscosity change and/or density, where the correlation is selected from the group consisting of a mathematical model and/or an empirical calibration curve. Both of these correlation methods provide extremely accurate and repeatable results, but because the empirical calibration method is less computationally expensive, it is the preferred one. It will be appreciated that deposition of material onto the sensor will affect the measurements. Conversely, in the absence of material depositing onto the sensor, the correlations are very accurate. The damping is a product of density and viscosity, thus if the density is affected, the viscosity is also. The density is calculated from the resonance frequency. From the damping and density (determined independently from resonance frequency), viscosity is determined.

Relevant patent documents related to resonator sensors and how they operate include, but are not necessarily limited to, U.S. Pat. Nos. 4,920,787; 5,837,885; 7,691,570; 8,291,750; 8,752,416; 9,267,872; 9,518,906; and 9,995,666; all of which are incorporated herein by reference in their entireties. Some of these resonator sensors are also called “tuning fork” resonators because the sensor employs a physical structure that resembles a tuning fork.

It will be appreciated that the actions performed in response to detecting the change, which action prevents, inhibits, and/or removes blockage of the subsea umbilical system may include, but are not necessarily limited to, discontinuing use of the unstable process treatment fluid, modifying the composition of the unstable process treatment fluid, applying a remediation solvent to remove blockage, applying a remediation acid to remove blockage, applying heat to remove blockage, applying sonic pulse to remove blockage, introducing a chemical species inhibitor into the subsea umbilical system to inhibit or prevent deposition of the chemical species within the subsea umbilical system and combinations thereof.

It will be appreciated that the benefits of the method described herein include one or more of the following, but possibly others as well. (1) The method can detect whether deposition is occurring at a particular location. (2) The method can obtain information on the rate and/or severity of the deposition. (3) The method can gauge whether an inhibitor may help prevent or reduce deposition, or a scavenger may be employed to remove a foulant or deposition. (4) The method can gauge whether an erroneous fluid has been applied. (5) The method can gauge whether the process treatment fluid has been contaminated.

And as noted, a wide variety of process treatment fluids are introduced through subsea umbilical systems and have the potential for fouling and/or deposition under certain conditions, such as temperature, pressure, and combination or mixing with an incompatible chemical.

It should be noted that the term “independently” as used herein with respect to a range means that any lower threshold may be combined with any upper threshold to give a suitable alternative range.

The invention will be further described with respect to the following Examples, which are not meant to limit the invention, but rather to further illustrate the various embodiments.

### Example 1

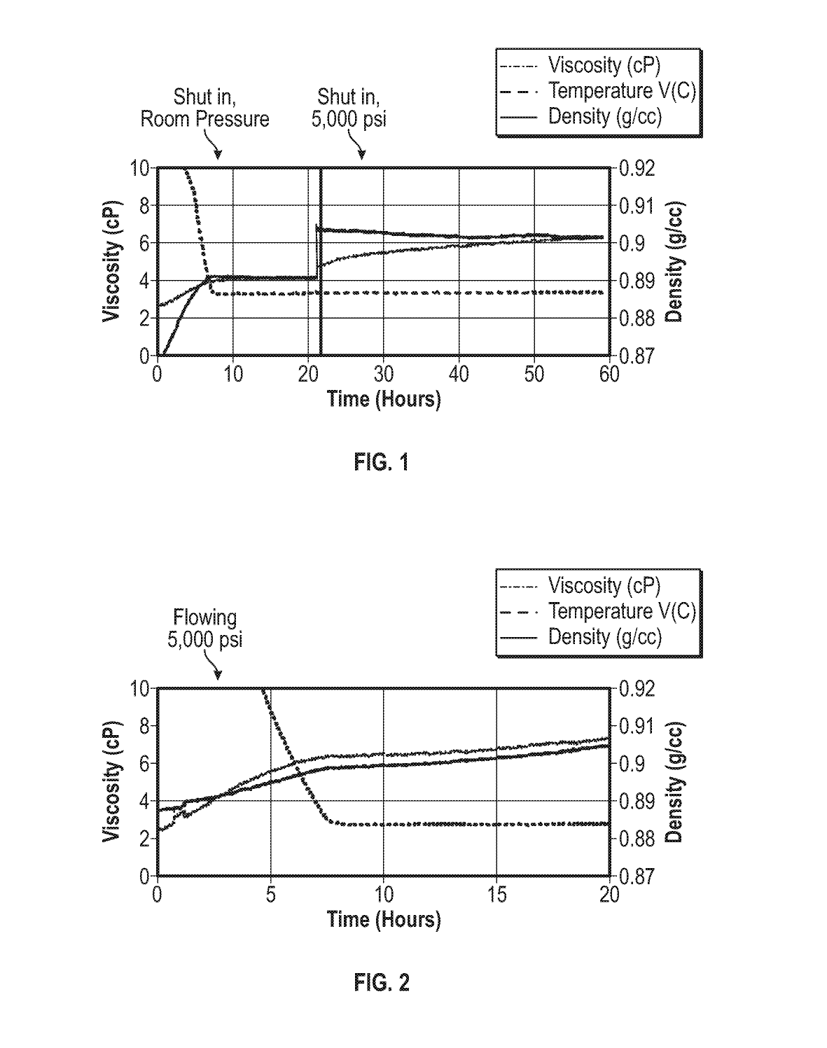

FIGS. 1 and 2 present viscosity and density measurements from a resonator sensor placed in a flow loop, using a sample of a paraffin inhibitor (sample A).

In an experiment where the results are presented in FIG. 1, the experiment was performed under static conditions. At time=0, the fluid temperature was 30° C. As the fluid is cooled down to 3° C. over a period of 8 hours, both the viscosity and density of the fluid were observed to increase. Once the temperature reached a constant value, both the viscosity and density reached a constant value as well. At time about 21 hours, the pressure in the flow loop was raised to 5000 psi (34 MPa) maintaining the static conditions. An immediate jump in viscosity associated with the increase in pressure was observed, followed by a gradual increase which was consistent with the physical model of structure formation. The density however shows a sudden increase upon pressurization, followed by a constant plateau.

For the results presented in FIG. 2, the same experiment was conducted using the same paraffin inhibitor (sample A), this time performed under flowing conditions. At time=0, the fluid temperature was 30° C. and the system was pressurized to 5000 psi (34 MPa). As the fluid was cooled down to 3° C. over a period of 8 hours, both the viscosity and density of the fluid were observed to increase. After the temperature reached the set value, one would expect the viscosity to increase as observed in the previous experiment (FIG. 1 results) due to structure formation. However, the density was expected to stay constant if the temperature and pressure remain constant. With torsional resonators (resonator sensors), the density measurement is highly sensitive to the inertial mass of the resonators. Any deposition of material on the resonators will have an impact on the density measurement response. Therefore, an increase in the measured value for density without an actual fluid density increase is a clear indication of deposition on the tuning fork resonators. Moreover, by showing the difference between static and flowing conditions, the effect of volumetric throughput upon deposition has been shown. Under static conditions, there is essentially no deposition occurring because the amount of fluid in contact with the resonators is relatively small. During flow however, a significantly higher amount of fluid will come into contact with the resonators, thus increasing the amount of material that is deposited on the resonators over time. This fact is apparent from the recorded difference between the density trace between FIGS. 1 and 2. During static conditions, at 3° C. and 5000 psi (34 MPa), the density is essentially constant with time. During flow, at 3° C. and 5000 psi (34 MPa), the density is gradually increasing which indicates material buildup on the surface of the resonators.

### Example 2

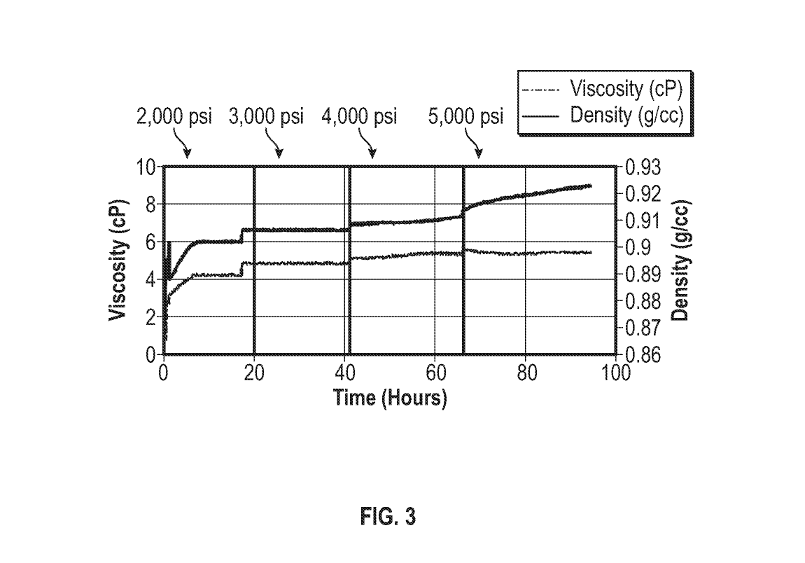

The results presented in FIG. 3 are from an experiment performed with a different paraffin inhibitor (sample B). In this experiment, at time=0, the fluid temperature was 30° C. and the system was pressurized to 2000 psi (14 MPa) while keeping the flow rate constant at 4 ml/min, the pressure was subsequently increased to 3000 psi (21 MPa) at time=17 hours, 4000 psi (28 MPa) at time=41 hours and 5000 psi (34 MPa) at time=66 hours. After the initial cool down was complete at time=8 hours, both the measured density and viscosity remained constant until the pressure is increased to 3000 psi (21 MPa) at the 17 hour mark. At 3000 psi, both the measured density and viscosity remain constant as expected. At 4000 psi (28 MPa), after the initial jump in density, a gradual increase that accelerated as time progressed was observed. After the initial jump in viscosity, a gradual increase was observed that seemed to reach a plateau at the 60 hour mark. Just as shown in the example of FIG. 1 results, the gradual increase in measured density was indicative of deposition taking place caused by the pressure increase. At 5000 psi (34 MPa), both the density and viscosity anomalies observed at 4000 psi (28 MPa) seem to accentuate, which is indicative of more pronounced deposition taking place.

### Example 3

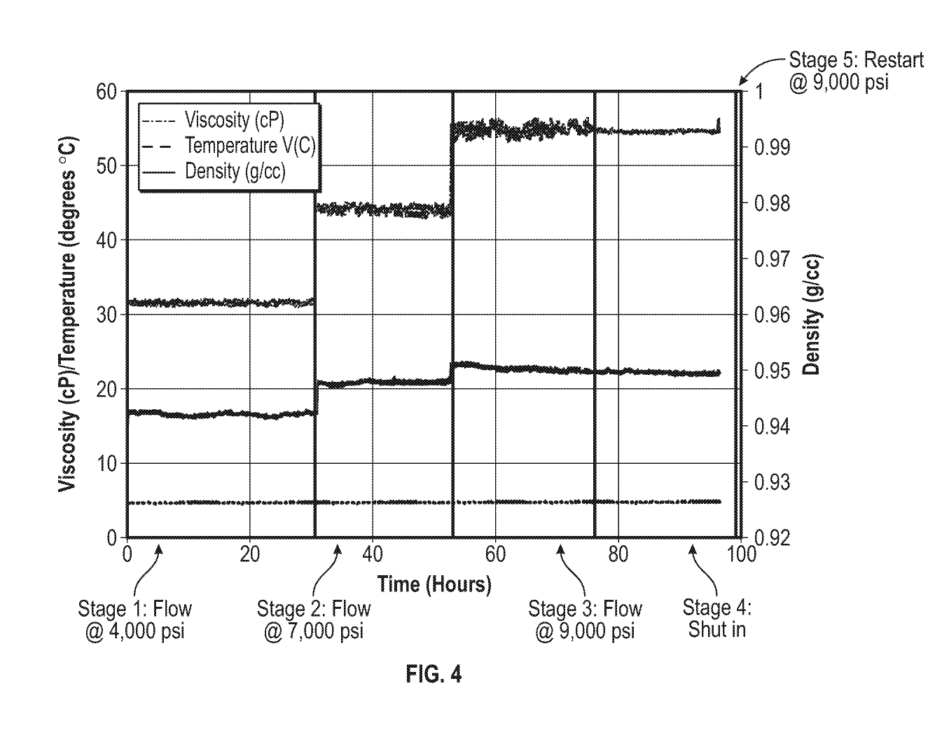

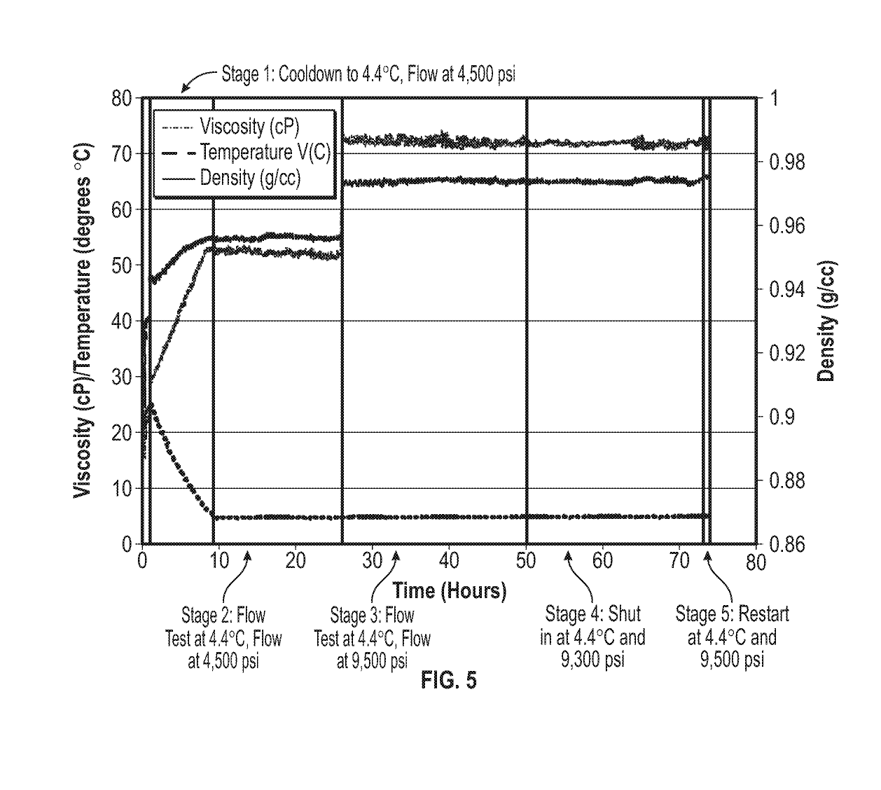

In FIG. 4 is shown the density and viscosity traces as a function of time for a sample of an asphaltene inhibitor chemical, which would be a typical production chemical to be injected through a subsea chemical injection system. The data presented shows the sensor response in terms of viscosity and density as the pressure was increased from 4000 psi to 9000 psi (28 MPa to 62 MPa), during flowing and static conditions.

An expected increase in viscosity and density measurements occur with each successive pressure increase, but afterwards the measurements remain relatively stable indicating the asphaltene inhibitor sample is stable and not depositing material on the sensor or within the flow loop.

### Example 4

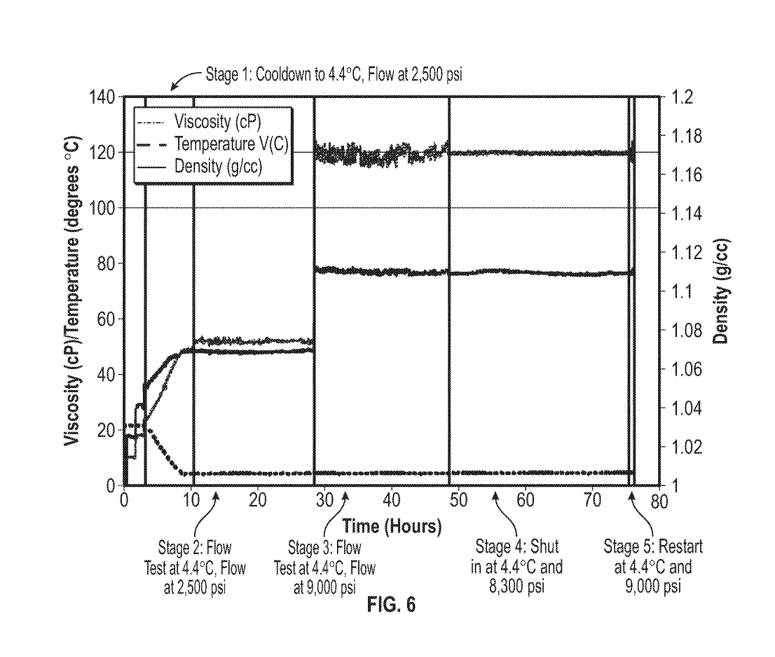

Shown in FIG. 5, are the density and viscosity traces as a function of time for a sample of a demulsifier chemical, which would be a typical production chemical to be injected through a subsea chemical injection system. The data presented shows the sensor response in terms of viscosity and density as the pressure was increased from 4500 psi to 9500 psi (31 to 65 MPa), during flowing and static conditions. During the initial cool down stage, the temperature was lowered from 25° C. to 4.4° C. while flowing at 4500 psi (31 MPa). An expected increase in viscosity and density measurements occur with each successive pressure increase, but afterwards the measurements remain relatively stable indicating the demulsifier sample is stable and not depositing material on the sensor or within the flow loop.

### Example 5

In FIG. 6, density and viscosity traces are shown as a function of time for a sample of hydrogen sulfide (H₂S) scavenger chemical, which would be a typical production chemical to be injected through a subsea chemical injection system. The data presented show the sensor response in terms of viscosity and density as the pressure was increased from 2500 psi to 9000 psi (17 MPa to 62 MPa), during flowing and static conditions. During the initial cool down stage, the temperature was lowered from 25° C. to 4.4° C. while flowing at 2500 psi (17 MPa). An expected increase in viscosity and density measurements occur with each successive pressure increase, but afterwards the measurements remain relatively stable indicating the H₂S scavenger sample is stable and not depositing material on the sensor or within the flow loop.

In the foregoing specification, the invention has been described with reference to specific embodiments thereof, and has been described as effective in providing methods for determining chemical species deposition in a subsea umbilical system. A particular advantage of the method described herein is that the chemical species deposition may be detected and/or measured while the fluid is flowing through the subsea umbilical system or conduit. However, it will be evident that various modifications and changes can be made thereto without departing from the broader scope of the invention as set forth in the appended claims. Accordingly, the specification is to be regarded in an illustrative rather than a restrictive sense. For example, specific petroleum-based fluids, other organic fluids, aqueous fluids, resonator sensors, torsional resonators, symmetrical sensors, flow lines, chemical species, foulants, foulant inhibitors, temperatures, pressures, time periods, falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of a method for measuring chemical species deposition in a subsea umbilical system that consists essentially of or consists of monitoring a resonator sensor in a flow line or well having an organic and/or aqueous fluid flowing therethrough, where the resonator sensor is selected from the group consisting of a torsional resonator and a symmetrical sensor, detecting a change in resonance of the resonator sensor indicating the deposition of a chemical species on the resonator sensor or significant change in process treatment fluid physical viscosity and density properties, and performing at least one action in response to detecting the change, which action prevents, inhibits, and/or removes blockage in the subsea umbilical system.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for detecting and inhibiting, preventing and/or removing chemical species deposition in a subsea umbilical system comprising:
monitoring a resonator sensor in a subsea umbilical system having a fluid selected from the group consisting of organic fluids, aqueous fluids, and combinations thereof, flowing therethrough, where the resonator sensor is selected from the group consisting of a torsional resonator and a symmetrical sensor; and
detecting a change in resonance of the resonator sensor indicating the deposition of a chemical species on the resonator sensor or significant change in process treatment fluid physical viscosity and density properties; and
performing at least one action in response to detecting the change, which action prevents, inhibits, and/or removes blockage in the subsea umbilical system.

2. The method of claim 1 where detecting a change in the resonance of the resonator comprises:
measuring a parameter selected from the group consisting of a resonant frequency, a resonant frequency shift, damping, and a combination thereof; and
correlating the parameter to a change selected from the group consisting of a viscosity change, a density change, and a combination thereof, where the correlation is selected from the group consisting of a mathematical model, an empirical calibration curve, and a combination thereof.

3. The method of claim 1 where the amount of change in resonance is detected over a time period and correlated to an amount of deposition of the chemical species on the resonator sensor.

4. The method of claim 1 further comprising subsequently removing the chemical species from the resonator sensor.

5. The method of claim 1 where performing the at least one action in response to detecting the change is selected from the group consisting of:
introducing a chemical species inhibitor into the subsea umbilical system to inhibit or prevent deposition of the chemical species within the subsea umbilical system;
introducing a chemical scavenger to remove the chemical species from the subsea umbilical system;
preventing the introduction of a component into the subsea umbilical system that contributes to the deposition of the chemical species; and
combinations thereof.

6. The method of claim 1 further comprising:
monitoring the resonator sensor at a first time where the fluid has an absence of a foulant inhibitor to give a first measurement;
monitoring the resonator sensor at a subsequent, second time where the fluid comprises a foulant inhibitor to give a second measurement;
comparing the first measurement and the second measurement to determine the effectiveness of the foulant inhibitor.

7. The method of claim 1 where detecting the change in resonance of the resonator sensor comprises:
measuring a baseline reading of the resonator sensor where the resonator sensor is free of chemical species deposition thereon;
measuring a subsequent reading of the resonator sensor; and
comparing the baseline reading with the subsequent reading to detect deposition of a chemical species on the resonator sensor.

8. The method of claim 1 further comprising measuring the temperature of the fluid at any time during the method.

9. A method for detecting and inhibiting, preventing and/or removing chemical species deposition in a subsea umbilical system comprising:
monitoring a resonator sensor in a subsea umbilical system having a fluid selected from the group consisting of organic fluids, aqueous fluids, and combinations thereof, flowing therethrough, where the resonator sensor is selected from the group consisting of a torsional resonator and a symmetrical sensor; and
detecting a change in resonance of the resonator sensor indicating the deposition of a chemical species on the resonator sensor or significant change in process treatment fluid physical viscosity and density properties, where detecting a change in the resonance of the resonator comprises:
measuring a parameter selected from the group consisting of a resonant frequency, a resonant frequency shift, damping, and a combination thereof; and
correlating the parameter to a change selected from the group consisting of a viscosity change, a density change, and a combination thereof, where the correlation is selected from the group consisting of a mathematical model, an empirical calibration curve, and a combination thereof; and
where the amount of change in resonance is detected over a time period and correlated to an amount of deposition of the chemical species on the resonator sensor
performing at least one action in response to detecting the change, which action prevents, inhibits, and/or removes blockage in the subsea umbilical system.

10. The method of claim 9 further comprising subsequently removing the chemical species from the resonator sensor.

11. The method of claim 9 where performing the at least one action in response to detecting the change is selected from the group consisting of:
introducing a chemical species inhibitor into the subsea umbilical system to inhibit or prevent deposition of the chemical species within the subsea umbilical system;
introducing a chemical scavenger to remove the chemical species from the subsea umbilical system;
preventing the introduction of a component into the subsea umbilical system that contributes to the deposition of the chemical species; and
combinations thereof.

12. The method of claim 9 further comprising:
monitoring the resonator sensor at a first time where the fluid has an absence of a foulant inhibitor to give a first measurement;
monitoring the resonator sensor at a subsequent, second time where the fluid comprises a foulant inhibitor to give a second measurement;
comparing the first measurement and the second measurement to determine the effectiveness of the foulant inhibitor.

13. The method of claim 9 where detecting the change in resonance of the resonator sensor comprises:
measuring a baseline reading of the resonator sensor where the resonator sensor is free of chemical species deposition thereon;
measuring a subsequent reading of the resonator sensor; and
comparing the baseline reading with the subsequent reading to detect deposition of a chemical species on the resonator sensor.

14. The method of claim 9 further comprising measuring the temperature of the fluid at any time during the method.

15. A method for detecting and inhibiting, preventing and/or removing chemical species deposition in a subsea umbilical system comprising:
monitoring a resonator sensor in a subsea umbilical system having a fluid selected from the group consisting of organic fluids, aqueous fluids, and combinations thereof, flowing therethrough, where the resonator sensor is selected from the group consisting of a torsional resonator and a symmetrical sensor;
measuring the temperature of the fluid at any time during the method; and
detecting a change in resonance of the resonator sensor indicating the deposition of a chemical species on the resonator sensor or significant change in process treatment fluid physical viscosity and density properties, where detecting the change in resonance of the resonator sensor comprises:
measuring a baseline reading of the resonator sensor where the resonator sensor is free of chemical species deposition thereon;
measuring a subsequent reading of the resonator sensor; and
comparing the baseline reading with the subsequent reading to detect deposition of a chemical species on the resonator sensor; and
performing at least one action in response to detecting the change, which action prevents, inhibits, and/or removes blockage in the subsea umbilical system.

16. The method of claim 15 where detecting a change in the resonance of the resonator comprises:
measuring a parameter selected from the group consisting of a resonant frequency, a resonant frequency shift, damping, and a combination thereof; and
correlating the parameter to a change selected from the group consisting of a viscosity change, a density change, and a combination thereof, where the correlation is selected from the group consisting of a mathematical model, an empirical calibration curve, and a combination thereof.

17. The method of claim 15 where the amount of change in resonance is detected over a time period and correlated to an amount of deposition of the chemical species on the resonator sensor.

18. The method of claim 15 further comprising subsequently removing the chemical species from the resonator sensor.

19. The method of claim 15 where performing the at least one action in response to detecting the change is selected from the group consisting of:
introducing a chemical species inhibitor into the subsea umbilical system to inhibit or prevent deposition of the chemical species within the subsea umbilical system;
introducing a chemical scavenger to remove the chemical species from the subsea umbilical system;
preventing the introduction of a component into the subsea umbilical system that contributes to the deposition of the chemical species; and
combinations thereof.

20. The method of claim 15 further comprising:
monitoring the resonator sensor at a first time where the fluid has an absence of a foulant inhibitor to give a first measurement;
monitoring the resonator sensor at a subsequent, second time where the fluid comprises a foulant inhibitor to give a second measurement;
comparing the first measurement and the second measurement to determine the effectiveness of the foulant inhibitor.
